(19) United States
(12) Patent Application Publication
(10) Pub. No.: US 2005/0278865 A1
(43) Pub. Date: Dec. 22, 2005

(54) Fishing tool

(76) Inventor: Michael West, Hamilton, MT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/154,789

(22) Filed: Jun. 15, 2005

Related U.S. Application Data
(60) Provisional application No. 60/580,074, filed on Jun. 15, 2004.

(51) Int. Cl. A01K 69/00; B26B 11/00

(52) U.S. Cl. 7/106; 7/118

(57) ABSTRACT

A fishing tool may include one or more components or tools that are movable between a retracted, storage position and an extended, use position. The fishing tool may include, for example, scissors and a pair of pliers, which may provide generally smooth clamping surfaces that may help a user put down a fishhook's barb. The fishing tool may also include a screwdriver combined with a hook hone. In addition, the fishing tool may include a pen and a needle member that is preferably sized and configured to be used to clean an eye of a fishhook and/or detangle knots in a fishing line. Further, the fishing tool may include a nail knot tool that is sized and configured to remove fishhooks and may include a combined screwdriver, bottle opener and wire cutter, if desired. The fishing tool may be coupled to a lanyard and a line clipper may also be coupled to the lanyard to create a fishing tool system.

### CROSS-REFERENCE TO RELATED APPLICATIONS

This application claims the benefit of and priority to U.S. Provisional Patent Application Ser. No. 60/580,074, filed Jun. 15, 2004 and entitled FISHING TOOL, which is hereby incorporated by reference herein in its entirety.

### BACKGROUND OF THE INVENTION

1. Field of the Invention

The present invention generally relates to tools and, in particular, to fishing tools.

2. Description of Related Art

Fishing is a widespread interest throughout the United States and the world. Many people are interested in diverse forms of fishing, and it is practiced by all types of people. For example, there are serious outdoorsmen that may fish almost every day during the fishing season and there are other people that only fish occasionally, such as during overnight camping trips.

It is well known that fishermen can fish for many different kinds of fish and fishing may occur in many different locations. For example, fishing may occur along streams, rivers and other types of tributaries. Fishing may also occur in ponds, lakes, seas, oceans and other bodies of water. It is also well known that various types of equipment may be used while fishing. For example, spinning and casting reels may be used depending, for example, upon the type of fish to be caught and/or the type of fisherman. In addition, different types of fishing rods, lines, tackle and bait may be used depending upon the type of fish intended to be caught.

Fly fishing is a well-known type of fishing and fly fishermen often use many different types of tools. Fly fishermen that tie their own flies may require even more tools and many of these tools may be contained within a tackle box. A typical tackle box for fly fishermen may include various types of fishing lines, hooks, scissors, knives and flies. Fly fishermen and other types of fisherman may also require other equipment such fishing vests, waders and other paraphernalia associated with the sport.

Many fishermen carry one or more tools with them while they fish. In particular, fly fishermen often carry several tools with them while fishing so that they can perform functions such as cutting the fishing line, trimming the flies and/or removing the fish from the hook. Unfortunately, it is often difficult for a fisherman to conveniently carry the large number of tools. In addition, because of the large number of tools, one or more tools may be easily lost or misplaced. There are several types of known tackle boxes and fishing vests whose purpose is to aid with the organization and placement of some common fishing tools, but frequently items fall out of these tackle boxes or fishing vests, or items are not returned to their original positions after use. Therefore, the desired tool may not be readily available or accessible. Consequently, a required tool could be missing at the very moment it is needed. Further, because of the large number of tools that may be necessary, a fisherman may have to transport a large amount of small tools every time one goes fishing.

### BRIEF SUMMARY OF THE INVENTION

A need therefore exists for a fishing tool that reduces or diminishes the above-described disadvantages and problems.

One aspect is a fishing tool that may combine several tools into a single tool. Advantageously, a fishing tool that combines several tools into a single unit may save storage space and time spent searching for the needed tool. In addition, instead of a fisherman being required to carry numerous small tools, the fisherman could simply carry one or two tools that perform multiple functions.

Another aspect is a fishing tool that may include several different components that allow the tool to perform multiple functions. For example, the fishing tool may include a lanyard ring or other type of line or device that allows the tool to be hung around the neck of the user. Significantly, because the tool may be hung around the neck of the user, it is readily available and accessible. In addition, the tool may include scissors that may, for example, be used to trim a fly for better presentation or to help repair or fix a fly before, during or after use. The tool may also include pliers. Desirably, the pliers may have a generally smooth, toothless configuration which may help perform tasks such as put down barbs on fishing hooks. The tool may also include a knife blade, a hook-hone/screwdriver, a hook-eye-cleaner/knot-detangler, pen, nail-knot-tool/hook-dislodger, a handle and the like. Of course, the tool may include desired number and/or combination of components depending, for example, upon the intended use of the tool. The tool may also include other components and may perfom other functions.

A further aspect is a fishing tool that may include multiple components and may have different sizes and configurations. For example, the fishing tool may be similar to the size and shape as the WENGER ESQUIRE™ series of pocket knives available from Wenger N.A. having representatives in Orangeburg, N.Y. Also, for example, the fishing tool may include one or more components such as scissors, pliers, a knife blade, a hook-hone/screwdriver, a hook-eye-cleaner/knot-detangler, a pen, a nail-knot-tool/hook-dislodger and/or other suitable components. The fishing tool, however, may have additional or fewer components and the fishing tool may be any desired size.

Yet another aspect is lanyard ring that may be attached to and/or consist of a portion of a fishing tool to permit the fishing tool to be hung on a string and worn around one's neck, to be attached to a fishing vest or to be fastened in some other form. The lanyard ring is preferably located proximate the opposite end of the tool from components such as scissors and pliers. Desirably, because the scissors and pliers are frequently used, the lanyard ring allows these components to be quickly and easily accessed. It will be appreciated that the lanyard ring may also be located in other suitable locations such as proximate a particular portion of the tool and/or near a particular component.

Still another aspect is a fishing tool that may include scissors. The scissors preferably open from and retract into a portion of the fishing tool. In addition, the scissors are preferably located at the opposite end of the lanyard ring to allow the scissors to be quickly and easily accessed. The scissors are preferably at least partially stored within the tool when not in use.

A further aspect is a fishing tool that may include a pair of pliers, such as needle nose pliers. The pliers may be used for crimping or putting down a fishhook barb, thus facilitating catch-and-release fishing if desired. The pliers preferably open from and retract into a portion of the fishing tool. Preferably, the pliers are twice as thick as the scissors to provide sturdier pliers, and the pliers are preferably located next to the scissors.

Still a further aspect is a fishing tool that may include a pair of pliers and all or at least a portion of the jaws of the pliers are preferably toothless and/or generally smooth. This toothless, generally smooth configuration may make it easier to crimp or put down a fishhook barb because the barb will not get lost in any teeth. Further, this toothless, generally smooth configuration may advantageously deter users from using the pliers for overly strenuous tasks that could damage the pliers. It will be appreciated that the jaws may have a first toothless, generally smooth portion and a second jagged portion having teeth, which may increase the functionality of the tool. For example, the smooth portion may be used to crimp or put down a fishhook barb, and the jagged portion may be used for other purposes. It will be appreciated that the pliers could have any suitable size, shape and configuration and number of teeth and/or smooth portions depending, for example, upon the intended use of the tool.

Another aspect is a fishing tool that may include a knife blade. The knife blade preferably opens from and retracts into a portion of the fishing tool. Preferably, the knife blade opens from and retracts into a portion opposite the scissors and the pliers. Also, the knife blade preferably pivots to the same end as the lanyard ring, which may be the end opposite the scissors and the pliers.

A further aspect is a fishing tool that may include a hook-hone/screwdriver. In particular, the fishing tool may include a hook hone, which may be combined with a screwdriver to save space and add functionality. The hook-hone/screwdriver preferably opens from and retracts into a portion of the fishing tool. Preferably, the hook-hone/screwdriver opens from and retracts into a portion opposite the scissors and the pliers. Also, the hook-hone/screwdriver is preferably positioned proximate the lanyard ring, which may be the opposite end to the scissors and the pliers. The hook-hone preferably includes a groove, which may act as a guide for the point of the hook, and the groove preferably includes a diamond steel surface or other suitable honing surface. The hook-hone/screwdriver preferably includes a size 0 Phillips-type screwdriver, which may be used to tighten a fly fishing reel, disassemble a fly fishing reel or to perform other tasks. Of course, the hook-hone/screwdriver may include other types and/or sizes of screwdrivers.

Yet another aspect is a fishing tool that may include a combination hook-eye-cleaner/knot-detangler. Combining a hook eye cleaner with a knot detangler may save space and increase efficiency. The combined hook-eye-cleaner/knot-detangler may include a retractable needle that comes out of the handle of the fishing tool and locks into place for use. Desirably, the hook-eye-cleaner/knot-detangler extends from and retract into the opposite end of the tool from the lanyard ring. A retractor member may be used to help extend and retract the hook eye cleaner/knot detangler, and the retractor member may be located on the same side as the knife and hook-hone/screwdriver. While a traditional hook eye cleaner is about ¼ inch long (0.6 centimeters), the hook-eye-cleaner/knot-detangler is preferably about ½ inch (about 1.3 centimeters) so that it may be used as knot detangler. The hook-eye-cleaner/knot-detangler may also be longer or shorter, if desired.

Still another aspect is a fishing tool that may include a pen. Desirably, the pen is located at the opposite end of the tool from the lanyard ring and it is retractable. The pen may be lock into position or be removable for use, and the pen may retract into the handle when not in use. A retractor member may be used to help extend and retract the pen, and the retractor member may be located on the opposite side as the retractor member for the hook-eye-cleaner/knot-detangler. Advantageously, the pen may be used by fishermen who have to fill out tags or keep a fishing log, for example.

A further aspect is a fishing tool that may include a combination nail knot tool and hook dislodger, which may save space and increase efficiency. The nail-knot-tool/hook-dislodger preferably opens from and retracts into a portion of the fishing tool. Preferably, the nail-knot-tool/hook-dislodger extends from and retracts into a portion opposite the scissors and the pliers. Also, the nail-knot-tool/hook-dislodger is preferably positioned proximate the lanyard ring, which may be the opposite end to the scissors and the pliers. The nail-knot-tool/hook-dislodger is preferably three-sided, channeled out about 3/16″ wide, open on both ends and made of steel. In addition, the channel preferably runs the entire length of the steel blade and the two sides of the channel are rounded at the end to serve as a hook dislodger. The rounded ends are advantageous in order to be less stressful to the fish when the hook is dislodged from the fish. The nail-knot-tool/hook-dislodger, however, could also have other suitable sizes, shapes and configurations.

Yet another aspect is a fishing tool that may include a screwdriver that may be used on fishing reels. In addition other components could be added in order to increase the overall functionality and/or change the size of the fishing tool. For example, a bottle opener, screwdriver and wire cutter could be added if desired. Desirably, the bottle opener, screwdriver and wire cutter may be combined into a single component, but these components could be separately or independently added or attached. Advantageously, combining these components into one may save space and increase efficiency. In particular, the bottle opener could be used to open traditional beverages, the screwdriver could be ⅛″ size so it can be used on fishing reels and the wire cutter could be used to cut fishing line. This tool preferably opens from and retracts into the same side as the knife and the hook-hone/screwdriver. Further, this tool may be located at the same end as the lanyard ring. One of ordinary skill in the art, however, will appreciate that this and the other components may be placed in any desired positions, arrangements, combinations, locations and/or orientations.

Another aspect is the fishing tool that may be combined with a line clipper, which may be part of the fishing tool or independent from the fishing tool. Desirably, the line clipper is attached to and/or supported by the same lanyard as the fishing tool so that the line clipper is readily accessible and obtainable by the fisherman. Thus, the line clipper may be located next to the fishing tool and always available for use.

A further aspect is the fishing tool that may have various sizes depending, for example, upon the number of tools and/or the intended use of the tool. In particular, the tool may be bigger and heavier, if desired. The bigger and heavier tool may, for example, be intended to be used by lake and ocean fishermen. On the other hand, the fishing tool may be smaller and lighter for other uses.

These and other aspects, features and advantages of the present invention will become more fully apparent from the following detailed description of preferred embodiments and appended claims.

### BRIEF DESCRIPTION OF THE DRAWINGS

The appended drawings contain figures of preferred embodiments to further clarify the above and other aspects, advantages and features of the present invention. It will be appreciated that these drawings depict only preferred embodiments of the invention and are not intended to limits its scope. The invention will be described and explained with additional specificity and detail through the use of the accompanying drawings in which:

FIG. 1 is a front view of an exemplary embodiment of a fishing tool, illustrating an exemplary lanyard attachment member;

FIG. 2 is another front view of the fishing tool shown in FIG. 1, illustrating an exemplary pair scissors;

FIG. 3 is yet another front view of the fishing tool shown in FIG. 1, illustrating an exemplary pair of pliers;

FIG. 4 is still another front view of the fishing tool shown in FIG. 1, illustrating an exemplary knife blade;

FIG. 5 is another front view of the fishing tool shown in FIG. 1, illustrating an exemplary hook-hone/screwdriver;

FIG. 6 is a rear view of the fishing tool shown in FIG. 1, illustrating an exemplary hook-eye-cleaner/knot-detangler;

FIG. 7 is yet another front view of the fishing tool shown in FIG. 1, illustrating an exemplary pen;

FIG. 8 is still another front view of the fishing tool shown in FIG. 1, illustrating an exemplary nail-knot-tool/hook-dislodger;

FIG. 9 is an enlarged view of a portion of the nail-knot-tool/hook-dislodger shown in FIG. 8;

FIG. 10 is a side view of the nail-knot-tool/hook-dislodger shown in FIG. 8;

FIG. 11 is a front view of another exemplary embodiment of a fishing tool, illustrating an exemplary bottle opener, an exemplary wire cutter and an exemplary screwdriver;

FIG. 12 is another front view of the fishing tool shown in FIG. 11, illustrating an exemplary pair of pliers; and

FIG. 13 is a front view of an exemplary embodiment of a fishing tool and an exemplary line clipper.

### DETAILED DESCRIPTION OF THE PREFERRED EMBODIMENTS

The present invention is generally directed towards a fishing tool. The principles of the present invention, however, are not limited to fishing tools. It will be understood that, in light of the present disclosure, the tool disclosed herein can be successfully used in connection with other types of tools, sports and the like.

Additionally, to assist in the description of the fishing tool, words such as top, bottom, front, rear, right and left may be used to describe the accompanying figures. It will be appreciated, however, that the fishing tool can be located in a variety of desired positions—including various angles, sideways and even upside down. Further, it will be appreciated that the figures are not necessarily drawn to scale. A detailed description of the fishing tool now follows.

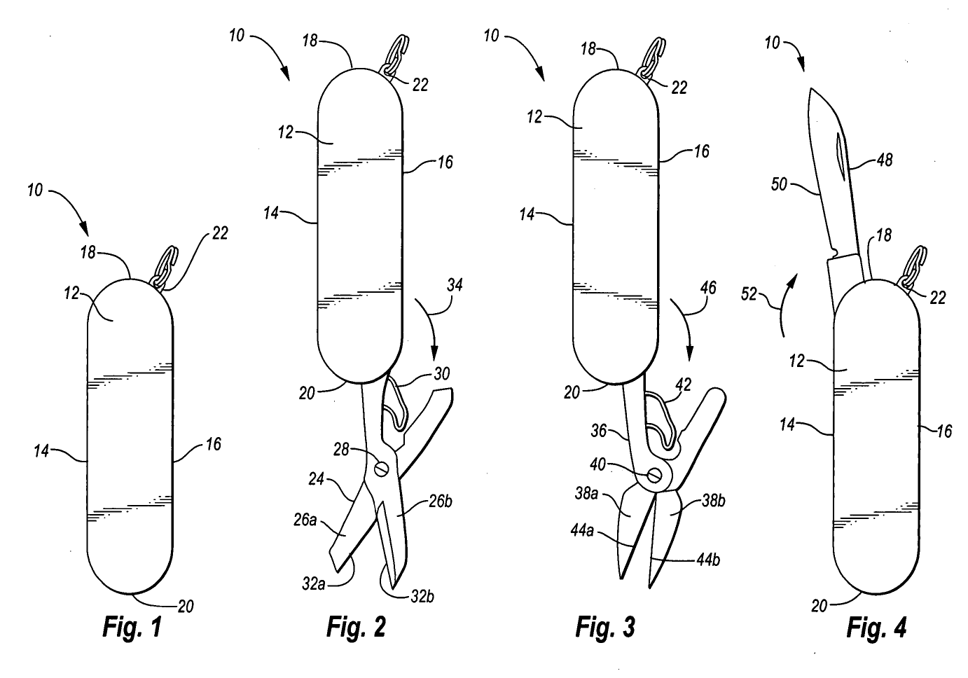

As shown in FIG. 1, the fishing tool 10 may include a number of components or tools. The fishing tool 10 may also combine several components or tools into a single unit, which may save storage space and may save time spent searching for a desired component. Also, rather than carrying several small tools that are easily lost, the user could simply carry one or two fishing tools that perform multiple functions.

As shown in FIG. 1, the fishing tool 10 may include a body 12 with a left side 14, a right side 16, a top end 18 and a bottom end 20. The body 12 may be constructed from a plurality of interconnected components or the body may be constructed as a unitary one-piece component.

As shown in the accompanying figures, the body 12 may include one or more receiving portions that are preferably sized and configured to receive one or more components and/or one or more portions of the components. Advantageously, the components may be sized and configured to extend, retract, pivot or otherwise move between a retracted, storage position (in which at least a portion of the tool is received within a receiving portion of the body 12) and an extended, use position (in which the tool is positioned for use). When a tool is positioned in the extended position, the body 12 may function as a handle for the tool. It will be appreciated that the fishing tool 10 could have a variety of suitable configurations and arrangements depending, for example, upon the intended purpose or use of the fishing tool.

The fishing tool 10 preferably includes a variety of components or tools, which are movable between a use position and a storage position. As shown for example in FIGS. 2 and 3, the components may be pivotally or otherwise movably connected to at least a portion of the body 12 and, thus, the component may be pivoted or otherwise moved among a variety of desired positions, including the retracted, storage position and the extended, use position. As shown for example in FIGS. 6 and 7, one or more of the components may be configured to extend in a generally linear direction and to retract in a generally linear direction. It will be appreciated that the fishing tool 10 may include components that move in a variety of other fashions and the components do not have to be movable.

The fishing tool 10 is preferably positioned to be quickly and easily accessible. For example, the fishing tool 10 may be configured to be attached to a cord, string, twine, cable, chain, line, lanyard or the like, and the lanyard may be connected to the user and/or to the user's clothing. In particular, to provide quick, easy access to the fishing tool 10, the lanyard may be conveniently hung around a neck of a user. Accordingly, the fishing tool 10 may include a lanyard attachment member 22 that is sized and configured to connect to and/or receive at least a portion of a lanyard. For example, as shown in FIG. 1, the lanyard attachment member 22 may be connected to a lanyard ring or loop that is configured to and receive at least a portion of lanyard. The lanyard attachment member 22 could also be directly or indirectly connected to at least a portion of a lanyard using clips, clamps and the like. The lanyard attachment member 22 is preferably positioned proximate the top end 18 of the fishing tool 10, but it could be positioned at another other suitable location. It will be appreciated that the fishing tool 10 does not require the lanyard attachment member 22 or the lanyard.

The lanyard attachment member 22 and one or more of the components of the fishing tool 10 may positioned to optimize or otherwise increase the efficiency of the fishing tool. For example, when the fishing tool 10 is hung using the lanyard attachment member 22, gravity may direct the bottom end 20 of the fishing tool in a generally downward direction and the top end 18 in a generally upward direction—making components that open proximate the bottom end 20 very convenient to use. Additionally, because the lanyard may obstruct access or use of components that open proximate the top end 18, the components that open proximate the bottom end 20 may be even more convenient to use. Because components that open proximate the bottom end 20 of the fishing tool 10 may be conveniently used, components that are most often used may be selected to open proximate the bottom end 20—thus increasing the efficiency of the fishing tool. For instance, as discussed in greater detail below, scissors, pliers, a pen, a hook-eye-cleaner/knot-detangler, or any combination thereof may be configured to open proximate the bottom end 20. Of course, any other components and/or other combination of components may be configured to open proximate any desired portion of the fishing tool 10 depending, for example, upon the intended purpose of the fishing tool.

As shown in FIG. 2, the fishing tool 10 may include scissors 24. The user may use the scissors 24 to trim a fly or other fishing lure for better presentation, to help repair or fix the fly and/or or to perform other tasks. The scissors 24 may include a pair of blades 26a, 26b that are pivotally connected at a location 28 using any suitable fastener, device or means. The scissors 24 may optionally include a resilient spring member 30 attached to the blade 26b. When the scissors 24 are closed, the blades 26a, 26b may compress the spring member 30, which thus exerts a force configured to move the scissors toward the opened position shown in FIG. 2. The blades 26a, 26b may have a cutting edge 32a, 32b respectively. As shown by the arrow 34, a user may pivot or otherwise move the scissors 24 from a retracted, storage position at least partially within the side of the body 12 to an extended, use position illustrated in FIG. 2. When finished using the scissors, the user may pivot or otherwise move the scissors 24 from the extended, use position back to the retracted, storage position. As shown in FIG. 2, the scissors 24 and the lanyard attachment member 22 are preferably positioned at generally opposing ends of the fishing tool to allow the scissors to be quickly and easily accessed. For example, when in the extended, use position shown in FIG. 2, the scissors 24 may be positioned proximate the bottom end 20 of the fishing tool 10 and the lanyard attachment member 22 may be positioned proximate the top end 18 of the fishing tool 10. Of course, the scissors 24 and the lanyard attachment member 22 may be disposed in other suitable locations, and the scissors 24 may have a variety of other a suitable components and configurations.

The fishing tool 10 may be configured to facilitate catch-and-release fishing, which is sometimes required by law. For example, to preserve the certain fish populations from becoming dangerously low, some governmental agencies have enacted regulations requiring that certain fish be released after being caught. Accordingly, these regulations help preserve the fish population because the fish are returned to the water. Unfortunately, some conventional fishhooks may fatally injure the fish and thus defeat the population-preserving intent of the catch-and-release regulations. For example, a conventional fishhook typically includes a barb that easily pierces the flesh of a fish, but is difficult to remove without harming the fish. In fact, when being removed, many barbs can tear or otherwise damage the flesh of a fish—which risks injury, infection or even death for the fish. As known by fisherman skilled in the art, crimping, clamping, or otherwise “putting down” the barb may minimize or otherwise reduce the damage associated with removing a fishhook from a fish.

To facilitate catch-and-release fishing, the fishing tool 10 may include pliers 36 that may be used to put down a barb. As shown in FIG. 3, the pliers 36 are preferably sized and configured to put down a barb on a fish hook of a fly or other fishing lure. Of course, the pliers 36 may be sized and configured to perform any other suitable task.

As shown in FIG. 3, the pliers 36 may include a pair of jaws 38a, 38b that are pivotally connected at a location 40 using any suitable fastener, device or means. The pliers 36 may optionally include a resilient, spring member 42. When the pliers 36 are closed, the jaws 38a, 38b may compress the spring member 42, which exerts a force configured to move the pliers toward an opened position. The jaws 38a, 38b may have a clamping surface 44a, 44b respectively. The pliers 36 may comprise needle-nose pliers, but could comprise other suitable types of pliers, clamping devices or crimping devices. The pliers 36 and/or the clamping surfaces 44a, 44b preferably have a width of about 0.2 inches (about 0.5 centimeters), which is about twice the preferable width of the scissors 24. The pliers 36 are also preferably positioned proximate the scissors 24, but the pliers and scissors could be located in other suitable positions.

As shown by the arrow 46, a user may pivot or otherwise move the pliers 36 from a retracted, storage position that is preferably at least partially within the side of the body 12 to an extended, use position illustrated in FIG. 3. When finished using the pliers 36, the user may pivot or otherwise move the pliers from the extended, use position back to the retracted, storage position. As shown in FIG. 3, the pliers 36 and the lanyard attachment member 22 are preferably positioned at generally opposing ends of the fishing tool 10 to allow the pliers to be quickly and easily accessed. Of course, the pliers 36 and the lanyard attachment member 22 may be in other suitable locations, and the pliers may have a variety of other suitable components, dimensions and configurations.

In one embodiment, the pliers 36 may include clamping surfaces that are sized and configured to put down a barb. Some conventional pliers include clamping surfaces that make putting down a barb difficult. For example, some conventional pliers may include clamping surfaces entirely covered with a plurality of excessively jagged surfaces, such as teeth that are sized and configured to grip an object. Unfortunately, when these teeth are larger than the barb, the barb can be unintentionally lost in the teeth—which can make putting down a barb difficult and awkward. In one preferred embodiment, one or both of the clamping surfaces 44a, 44b of the jaws 38a, 38b may advantageously include a generally smooth portion that is sized and configured to put down a barb. The generally smooth portion may be generally flat and/or substantially free of teeth, which may advantageously facilitate putting down a barb. In some instances, because the pliers 36 may have a relatively small size and generally smooth clamping surfaces, that may deter users from attempting overly strenuous tasks that could damage the pliers.

The generally smooth portion may cover all or a portion of a clamping surface 44 of the jaws 38 of the pliers 36. Thus, the clamping surface 44 may include one or more generally smooth portions and/or one or more jagged portions containing teeth. For example, it will be appreciated that, by increasing the size of the fishing tool, it may be possible to include pliers including jaws having at least a portion of their clamping surface generally smooth and at least a portion of their clamping surface containing jagged teeth. Advantageously, the generally smooth portions could be used for putting down a barb and the jagged portions could be used for other uses—thus increasing the functionality of the pliers. If desired, the front portion of a clamping surface could be generally smooth and the back portion of the clamping surface could be jagged. The pliers, however, could have any suitable size, shape and configuration depending, for example, upon the intended use of the fishing tool 10.

As shown in FIG. 4, the fishing tool 10 may include a knife 48 with a sharp edge 50. As shown by the arrow 52, a user may pivot or otherwise move the knife 48 from a retracted, storage position that is preferably at least partially within the side 14 of the body 12 to an extended, use position illustrated in FIG. 4. When finished using the knife 48, the user may pivot or otherwise move the knife from the extended, use position back to the retracted, storage position. As shown in FIG. 4, in the extended position, the knife 48 is preferably positioned at the top end 18 of fishing tool 10 and proximate the lanyard attachment member 22.

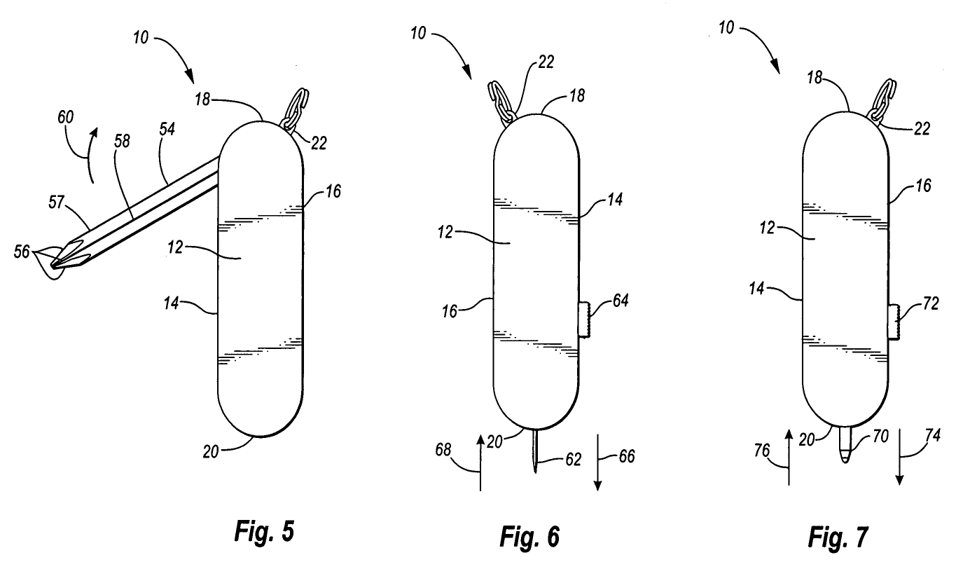

As shown in FIG. 5, the fishing tool 10 may also include a hook-hone/screwdriver 54. The hook-hone/screwdriver 54 preferably includes a plurality of flanges 56 that form a size 0 Phillips-type screwdriver proximate the end of an elongated body portion 57 of the hook-hone/screwdriver tool 54. Advantageously, a size 0 Phillips-type screwdriver is the most often used in connection with fly-fishing reels, and the screwdriver may be used, for example, to tighten and/or disassemble a fly fishing reel. The elongated body portion 57 may have a generally flat configuration, a generally cylindrical configuration or other suitable configuration. Of course, the end of the elongated body portion 57 may also be formed into other types and/or sizes of screwdrivers.

As shown in FIG. 5, in addition to providing a screwdriver, the hook-hone/screwdriver 54 is also preferably sized and configured to provide a hook-hone with a groove or other hook receiving portion 58 having a honing surface. The honing surface may consist of flat diamond steel or other material suitable for honing the point of a hook. It will be appreciated that the groove 58 may advantageously be used as a guide for the point of the hook. The groove 58 preferably is disposed proximate the middle of the elongated body portion 57 and may extend along all or a portion of the length of the elongated body portion 57. As shown by the arrow 60, a user may pivot or otherwise move the hook-hone/screwdriver 54 from a retracted, storage position in which at least a portion of the component is partially disposed within the side 14 of the body 12 to an extended, use position. When finished using the hook-hone/screwdriver the user may pivot or otherwise move the hook-hone/screwdriver from the extended, use position back to the retracted, storage position. Similar to the knife 48, in the extended position, the hook-hone/screwdriver 54 is preferably positioned at the top end 18 of fishing tool 10 and proximate the lanyard attachment member 22.

As shown in FIG. 6, the fishing tool 10 may include a hook-eye-cleaner/knot-detangler tool 62. The hook-eye-cleaner/knot-detangler 62 preferably includes an elongated, slender implement (such as, a needle) constructed from metal or another suitable material. Advantageously, the hook-eye-cleaner/knot-detangler 62 may be sized and configured to be partially or completely inserted through an eye of a fishhook. Accordingly, to clean the eye of a fishhook, a user may insert all or a portion of the hook-eye-cleaner/knot-detangler 62 into and/or through the eye of the fishhook. Also, with the slender hook-eye-cleaner/knot-detangler 62, the user may insert the hook-eye-cleaner/knot-detangler 62 into at least a portion of a knot formed in a tangled fishing line and manipulate the knot until the knot is detangled. By combining a hook-eye cleaner with a knot detangler, it may save space and make the fishing tool 10 more efficient. While the traditional hook eye cleaner has a one-quarter (¼) inch (0.6 centimeters) exposed, usable length, the hook-eye-cleaner/knot-detangler 62 preferably has a length greater than about one-quarter (¼) inch (0.6 centimeters) and, more preferably, at least about one-half (½) inch (about 1.3 centimeters) to about three-quarters (¾) of an inch (about 1.9 centimeters) to facilitate detangling knots. The hook-eye-cleaner/knot-detangler 62 may also be longer or shorter, if desired.

Preferably, a user may move the hook-eye-cleaner/knot-detangler 62 from a retracted, storage position in which it is at least partially disposed within the bottom end 20 of the body 12 to an extended, use position illustrated in FIG. 6. When finished using the hook-eye-cleaner/knot-detangler 62, the user may advantageously move the hook-eye-cleaner/knot-detangler from the extended, use position back to the retracted, storage position. As shown in FIG. 6, the hook-eye-cleaner/knot-detangler 62 and the lanyard attachment member 22 are preferably positioned at generally opposing ends of the fishing tool to allow the hook-eye-cleaner/knot-detangler to be quickly and easily accessed. Of course, the hook-eye-cleaner/knot-detangler 62 and the lanyard attachment member 22 may be location in any suitable locations.

As shown in FIG. 6, the fishing tool 10 may include a retractor 64, which may be connected or otherwise coupled to the hook-eye-cleaner/knot-detangler 62 and used to slide or otherwise move the hook-eye-cleaner/knot-detangler between the storage and use positions. As the user pushes the retractor 64 in a generally linear direction 66, the hook-eye-cleaner/knot-detangler 62 may extend from the storage position toward the use position in the generally linear direction 66. Similarly, as the user pushes the retractor 64 in a generally linear direction 68, the hook-eye-cleaner/knot-detangler 62 may retract from the use position toward the storage position in the generally linear direction 68. The retractor 64 preferably is positioned along the side 14 of the fishing tool 10 proximate the knife 48 and the hook-hone/screwdriver 54, but the retractor member could be positioned in other locations. The hook-eye-cleaner/knot-detangler 62 may also be lockable in the storage position, in the use position, or both using, for example, one or more notches formed in the body 12 of the fishing tool 10. In one embodiment, a replaceable gas-pressurized cartridge may be provided to help move the hook-eye-cleaner/knot-detangler 62 into a desired position. Advantageously, because the retractor member 64 may be used to extend and retract the hook-eye-cleaner/knot-detangler 62, the hook-eye-cleaner/knot-detangler may have a relatively slender size and configuration (such as, a needle) that is especially suited for both cleaning a hook and detangling knots and that requires less space than bulkier, less effective tools. Indeed, bulkier tools may be less effective in cleaning a fishhook eye or detangling a knot. Of course, it will be appreciated that the hook-eye-cleaner/knot-detangler 62 may have a variety of sizes and configurations and may be slid, pivoted, or moved between the storage and use positions in any suitable manner and by any suitable means.

As shown in FIG. 7, the fishing tool 10 may include a pen 70. The pen 70 may be a ballpoint pen, a roller pen or other suitable writing instrument. Advantageously, a fisherman or other user may use the pen 70 to fill out tags or keep a fishing log, for example. Preferably, a user may move the pen 70 from a retracted, storage position in which the pen is at least partially within the bottom end 20 of the body 12 to an extended, use position illustrated in FIG. 7. When finished using the pen 70, the user may advantageously move the pen from the extended, use position back to the retracted, storage position. As shown in FIG. 7, the pen 70 and the lanyard attachment member 22 are preferably-positioned at generally opposing ends of the fishing tool 10 to allow the pen to be quickly and easily accessed. Of course, the pen 70 and the lanyard attachment member 22 may be disposed in any other suitable locations.

As shown in FIG. 7, the fishing tool 10 may include a retractor 72 that may be connected or otherwise coupled to the pen 70 and used to slide or otherwise move the pen between the storage and use positions. For example, as the user pushes the retractor 72 in a generally linear direction 74, the pen 70 may extend from the storage position toward the use position in the generally linear direction 74. Similarly, as the user pushes the retractor 72 in a generally linear direction 76, the pen 70 may retract from the use position toward the storage position in the generally linear direction 76. The retractor 72 preferably is positioned along the side 16 of the fishing tool 10 proximate the scissors 24 and the pliers 36, but the retractor could be positioned in other locations. Optionally, the pen 70 may be lockable in the storage position, in the use position, or both using, for example, one or more notches formed in the body 12 of the fishing tool 10. In one embodiment, a replaceable gas-pressurized cartridge may be provided to help move the pen into a desired position. Of course, it will be appreciated that the pen 70 may have a variety of sizes and configurations and may be slid, pivoted, or moved between the storage and use positions in any suitable manner and by any suitable means. An exemplary embodiment of a retractable pen that may be locked in various positions using one or more notches or including a gas-pressurized cartridge for moving a pen is the VICTORINOX SIGNATURE™ series of pocket knives available from Swiss Army Brands, Inc. having representatives in Shelton, Conn.

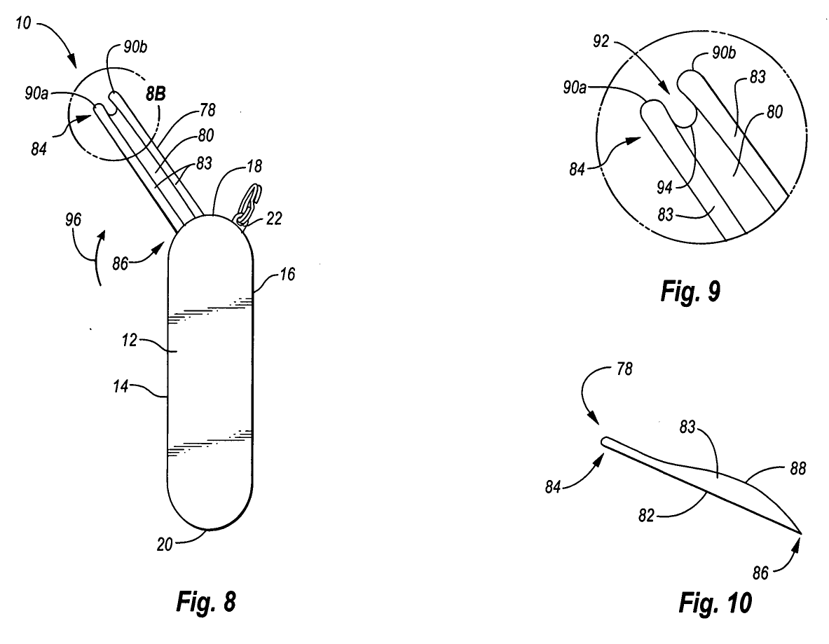

As shown in FIGS. 8-10, the fishing tool 10 may include a nail-knot-tool/hook-dislodger tool 78. Advantageously, the nail-knot-tool/hook-dislodger 78 may be sized and configured to assist in tying knots. For example, the nail-knot-tool/hook-dislodger 78 may include an elongated body with a channel or recessed portion 80, a generally flat end 82 formed on an opposite surface of the channel 80, a pair of wall portions 83 defining the recessed portion 80, a first end 84 positioned away from the body 12 of the fishing tool 10 and a second end 86 positioned proximate the body 12 of the fishing tool 10. The wall portions 83 are preferably spaced apart to form the got recessed portion 80 that is about three-sixteenths ( 3/16) of an inch (about 0.47 centimeters) wide and may extend along all or a portion of the elongated body. As best seen in FIG. 10, the wall portions 83 may have a generally curvilinear shape, including a greater height proximate a portion 88 that tapers to a lesser height proximate the ends 84 and 86 of the nail-knot-tool/hook-dislodger 78.

The nail-knot-tool/hook-dislodger 78 may be sized and configured to assist in dislodging or otherwise removing a fishhook from a fish. For example, in one embodiment, as best seen in FIG. 9, the wall portions 83 may include tips 90a, 90b, which may define a notch, groove or other opening 92 bounded by in an interior portion 94. The tips 90a, 90b preferably have a generally rounded, blunt configuration. The generally rounded tips 90a, 90b are advantageously less stressful to the fish when the hook is dislodged from the fish. As shown in FIG. 9, the generally rounded tips 90a, 90b may have a length that is less than or equal to about the width of the wall portions 83, which may also reduce the stress to the fish. In another embodiment, the generally rounded tips 90a, 90b may have a length that is less than or equal to about twice the width of the wall portions 83. In a further embodiment, the generally rounded tips 90a, 90b may have a width of about 0.07 inches (about 0.18 centimeters) and a length of about 0.14 inches (about 0.36 centimeters). Of course, the nail-knot-tool/hook-dislodger 78 could also have other suitable sizes, shapes and configurations. Significantly, because the nail-knot-tool/hook-dislodger 78 may be used to both tie knots and dislodge fishhooks, additional space may be saved, making the fishing tool 10 more functional.

As shown, by the arrow 96 in FIG. 8, a user may pivot or otherwise move the nail-knot-tool/hook-dislodger 78 from a retracted, storage position in which it is at least partially disposed within the side 14 of the body 12 toward an extended, use position. When finished using the nail-knot-tool/hook-dislodger 78, the user may pivot or otherwise move the nail-knot-tool/hook-dislodger from the extended, use position back to the retracted, storage position. In the extended position, the nail-knot-tool/hook-dislodger 78 is preferably positioned at the top end 18 of fishing tool 10 and proximate the lanyard attachment member 22.

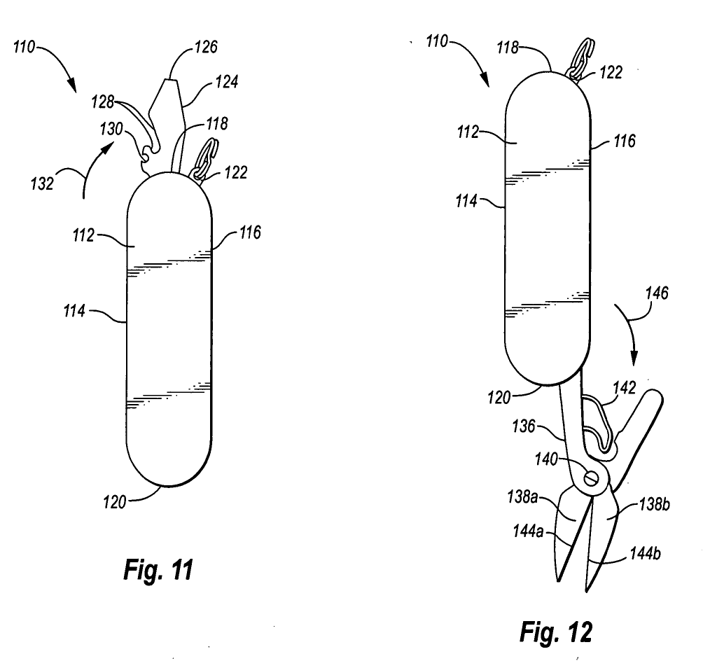

As shown in FIG. 11, another exemplary embodiment of a fishing tool 110 may include a body and one or more receiving portions that are sized and configured to receive a plurality of components in a similar manner as the fishing tool 10 shown in FIG. 1. The fishing tool 110 may be larger than the fishing tool 10, but the fishing tools may have any suitable sizes or relative sizes. As shown in FIG. 11, the fishing tool 110 may include a body 112, a left side 114, a right side 116, a top end 118 and a bottom end 120. The fishing tool 110 may also include a lanyard attachment member 122. If desired, the fishing tool 110 may include any combination one or more of the components or tools described above in connection with the fishing tool 10.

As shown in FIG. 11, the fishing tool 110 may include a flathead screwdriver 124, which preferably has a small size adapted to be used on fishing reels. If desired, other tools could be added to increase the overall functionality and/or size of the fishing tool 110. For example, a bottle opener, screwdriver and wire cutter could be added. Desirably, the bottle opener, screwdriver and wire cutter are combined into a single tool, but these tools could be separately or independently added. By combining these three individual tools, space could be saved and the fishing tool could be more efficient.

In greater detail, as shown in FIG. 11, the screwdriver 124 may include a generally flat end 126 having a width of about one-eighth (⅛) of an inch (about 0.3 centimeters), which may be especially useful for working on fishing reels. Additionally, the screwdriver 124 may include a curved edge defining one or more surfaces 128 sized and configured to open bottles. Further, the screwdriver may include a wire cutter 130, which could be used to cut fishing line. As shown by the arrow 132, a user may pivot or otherwise move the screwdriver 124 from a retracted, storage position in which at least a portion of the screwdriver is disposed within the side 114 of the body 112 to an extended, use position illustrated in FIG. 11. When finished using the screwdriver 124, the user may pivot or otherwise move the screwdriver from the extended, use position back to the retracted, storage position. In the extended position, the screwdriver 124 is preferably positioned at the top end 118 of fishing tool 10 and proximate the lanyard attachment member 122. It will be appreciated that these and other components may be placed in any desired positions, locations and/or orientations.

As shown in FIG. 12, the fishing tool 110 may also include pliers 136, which preferably is longer and/or thicker than the pliers 36 shown in FIG. 3. The pliers 136 are preferably sized and configured to put down a barb on a fishhook or other suitable tasks. The pliers 136 may have a variety of configurations. For example, as shown in FIG. 10, the pliers 136 may include a pair of jaws 138a, 138b that are pivotally connected at a location 140 using any suitable fastener, device or means. The pliers 136 may optionally include a resilient, spring member 142. When the pliers 136 are closed, the jaws 138a, 138b may compress the spring member 142, which thus exerts a force configured to move the pliers toward an opened position. The jaws 138a, 138b may have clamping surfaces 144a, 144b respectively. The pliers 136 may comprise needle-nose pliers, but could comprise other suitable types of pliers, clamping devices or crimping devices. As shown by the arrow 146, a user may pivot or otherwise move the pliers 136 from a retracted, storage position in which at least a portion of the pliers is disposed within the side of the body 112 to an extended, use position illustrated in FIG. 12. When finished using the pliers 136, the user may pivot or otherwise move the pliers 136 from the extended, use position back to the retracted, storage position. As shown in FIG. 12, the pliers 136 and the lanyard attachment member 122 are preferably positioned at generally opposing ends of the fishing tool to allow the pliers to be quickly and easily accessed. It will be appreciated that the pliers 136 and the lanyard attachment member 122 could be disposed in other suitable locations and the pliers may have a variety of suitable components, dimensions and configurations.

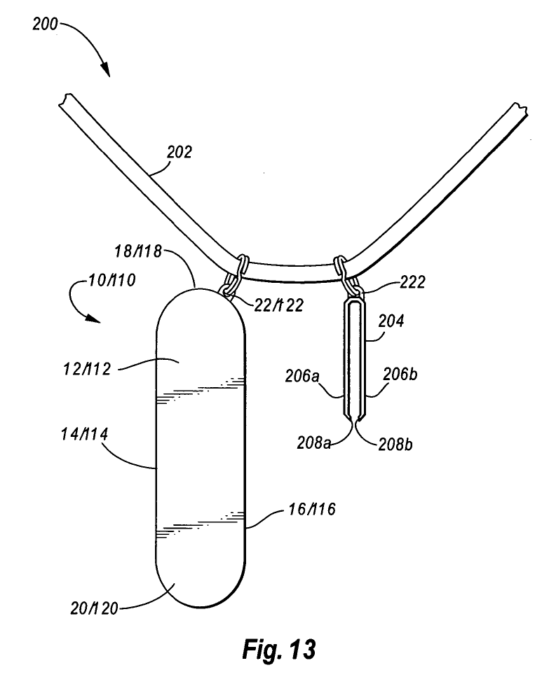

Advantageously, the fishing tools 10, 110 may be used in combination with a line clipper, which may be part of the fishing tool or coupled to the fishing tool. As shown in FIG. 13, a fishing tool system 200 may include a lanyard 202, a fishing tool (such as, the fishing tools 10, 110) coupled to the lanyard, and a line clipper 204 coupled to the lanyard. The line clipper 204 may include clipping members 206a, 206b with cutting edges 208a, 208b, respectively. The clipping members 206a, 206b may be pressed together such that the cutting edges 208a, 208b may engage and cut a fishing line. Preferably, the line clipper 204 is coupled to the lanyard 202 using a lanyard attachment member 222, and the fishing tools 10, 110 are also coupled to the lanyard 202 using a lanyard attachment member 22, 122. Desirably, the line clipper 204 is attached to the same lanyard as the fishing tool so that it is readily accessible and obtainable. Thus, the line clipper may be located next to the fishing tool and always available for use.

Further, coupling both the fishing tool 10, 110 and the line clipper 204 to the same lanyard may be used to more effectively market the fishing tool. For example, the line clippers 204 may be readily recognizable to a fisherman (but a fishing tool may appear to be an ordinary pocket knife). Accordingly, a store manager may attach both the line clipper 204 and the fishing tool 10, 110 to the same lanyard for display—which may indicate that the fishing tool is a fishing tool, rather than an ordinary pocket knife. If desired, the store manager may place the fishing tool system 200 in a display case, on a mannequin, or in any other suitable display, which may facilitate sales of the fishing tool and/or the fishing tool system.

It will be appreciated that the fishing tools 10, 110 may have a variety of suitable components, sizes and configurations. For example, the fishing tool 110 is preferably about three and five-eighths (3⅝) inches (about 9.2 centimeters) long and may have a size and shape similar to the WENGER ESQUIRE™ series of pocket knives available from Wenger N.A. having representatives in Orangeburg, N.Y. Also, the fishing tool 10 is preferably about two and three-eighths (2⅜) inches (about 6 centimeters) long and may have a size and shape similar to the VICTORINOX SIGNATURE™ series of pocket knives available from Swiss Army Brands, Inc. having representatives in Shelton, Conn. Of course, the fishing tool may have various sizes depending, for example, upon the number of tools and/or the intended use of the tool. In particular, the tool may be bigger and heavier, if desired. The bigger and heavier tool may, for example, be intended to be used by lake and ocean fishermen.

Although this invention has been described in terms of certain preferred embodiments, other embodiments apparent to those of ordinary skill in the art are also within the scope of this invention. Accordingly, the scope of the invention is intended to be defined only by the claims which follow.

1. A fishing tool system comprising:
a fishing tool including:
a body including at least one receiving portion; and
pliers movable between a first position in which at least a portion of the pliers is received within the at least one receiving portion of the body and a second position in which the pliers are positioned for use, the pliers comprising:
a first jaw member having a first clamping surface that includes a first generally smooth portion; and
a second jaw member having a second clamping surface that includes a second generally smooth portion.

2. The fishing tool system as in claim 1, wherein the first clamping surface further includes a first jagged portion and wherein the second clamping surface further includes a second jagged portion.

3. The fishing tool system as in claim 1, wherein first clamping surface further includes a first jagged portion spaced apart from a tip of the first jaw member and wherein the second clamping surface further includes a second jagged portion spaced apart from a tip of the second jaw member.

4. The fishing tool system as in claim 1, wherein the first generally smooth portion is disposed proximate a distal end of the first jaw member and wherein the second generally smooth portion is disposed proximate a distal end of the second jaw member.

5. The fishing tool system as in claim 1, wherein the fishing tool further comprises:
a pen;
a first retractor member configured to move the pen from a first position in which at least a portion of the pen is received within the at least one receiving portion of the body and a second position in which the pen is positioned for use;
a needle member; and
a second retractor member configured to move the needle member from a first position in which at least a portion of the needle member is received within the at least one receiving portion of the body and a second position in which the needle member is positioned for use.

6. The fishing tool system as in claim 1, wherein the fishing tool further comprises:
a first retractor member configured to move a tool in a generally linear fashion between a first position in which at least a portion of the tool is received within the at least one receiving portion of the body and a second position in which the tool is positioned for use; and
a second retractor member configured to move a tool in a generally linear fashion between a first position in which at least a portion of the tool is received within the at least one receiving portion of the body and a second position in which the tool is positioned for use;
wherein the first retractor member is positioned proximate a first portion of the body of the fishing tool and the second retractor member is positioned proximate a second, opposing portion of the body of the fishing tool.

7. The fishing tool system as in claim 1, wherein the fishing tool further comprises:
a needle member configured to move from a first position in which at least a portion of the needle member is received within the at least one receiving portion of the body and a second position in which the needle member is positioned for use, the needle member being at least about 0.5 inches long.

8. The fishing tool system as in claim 1, wherein the fishing tool further comprises:
a needle member configured to move from a first position in which at least a portion of the needle member is received within the at least one receiving portion of the body and a second position in which the needle member is positioned for use, the needle member being at least about 0.75 inches long.

9. The fishing tool system as in claim 1, wherein the fishing tool further comprises:
a nail-knot-tool/hook-dislodger configured to move between a first position in which at least a portion of the nail-knot-tool/hook-dislodger is received within the at least one receiving portion of the body and a second position in which the nail-knot-tool/hook-dislodger is positioned for use, the nail-knot-tool/hook-dislodger comprising:
an elongated body portion connected to the body of the fishing tool having a plurality of wall portions having a generally rounded tip.

10. The fishing tool system as in claim 1, further comprising:
a lanyard; and
a line clipper;
wherein the line clippers and the fishing tool are coupled to the lanyard.

11. The fishing tool system as in claim 1, wherein the fishing tool further comprises:
a lanyard attachment member positioned proximate a first portion of the body of the fishing tool;
wherein, when the pliers are in the second position in which the pliers are positioned for use, the pliers are proximate a second, opposing portion of the body of the fishing tool.

12. A fishing tool system comprising:
a fishing tool comprising:
a body;
an elongated body portion connected to the body;
a plurality of flanges formed in the elongated body portion, the flanges forming at least a portion of a Phillips screwdriver; and
a honing surface adapted to hone a fishhook, the honing surface at least partially disposed on the elongated body portion.

13. The fishing tool system as in claim 12, wherein the fishing tool further comprises:
a fishhook receiving portion formed in the elongated body portion, the fishhook receiving portion including at least a portion of the honing surface.

14. The fishing tool system as in claim 12, wherein the fishing tool further comprises:
a groove formed in the elongated body portion, the groove including at least a portion of the honing surface.

15. The fishing tool system as in claim 14, wherein the groove extends along at least a portion of elongated body portion.

16. The fishing tool system as in claim 12, further comprising:
a lanyard; and
a line clipper;
wherein the line clipper and the fishing tool are coupled to the lanyard.

17. A method for altering a fishhook, the method comprising:
moving pliers from a retracted position in which at least a portion of the pliers is received within at least one receiving portion of a body of a fishing tool to an extended position in which the pliers are positioned for use, the pliers including a first clamping surface that includes a first generally smooth portion and a second clamping surface that includes a second generally smooth portion; and
putting down a barb of a fishhook using the first and second generally smooth portions of the pliers.

18. The method as in claim 17, wherein the first clamping surface further includes a first jagged portion and wherein the second clamping surface further includes a second jagged portion.

19. The method as in claim 17, wherein first clamping surface further includes a first jagged portion spaced apart from a tip of the first jaw member and wherein the second clamping surface further includes a second jagged portion spaced apart from a tip of the second jaw member.

20. The method as in claim 17, wherein the first generally smooth portion is disposed proximate a distal end of the first jaw member and wherein the second generally smooth portion is disposed proximate a distal end of the second jaw member.
